(19) United States
(12) Patent Application Publication
(10) Pub. No.: US 2002/0129966 A1
(43) Pub. Date: Sep. 19, 2002

(54) Cable, especially for installation into a canal or a pipe

(76) Inventors: Reiner Schneider, Ebersdorf (DE); Waldemar Stocklein, Coburg (DE)

Correspondence Address: CORNING CABLE SYSTEMS LLC, P O BOX 489, HICKORY, NC, 28603, US

(21) Appl. No.: 10/094,791

(22) Filed: Mar. 11, 2002

(30) Foreign Application Priority Data
Mar. 13, 2001 (DE) 10111963.1-51

(51) Int. Cl. H01B 7/36

(52) U.S. Cl. 174/112

(57) ABSTRACT

A cable, which is suitable for installation into a canal or pipe, has a cable core (ZE, OA) and a cable jacket (KM1, KM2) surrounding the cable core. The cable jacket (KM2) has discrete elevations (LSA) on a base material of the cable jacket, which are formed as longitudinal strips stretching in the longitudinal direction of the cable (OC1). By providing the longitudinal strips (LS), the gliding friction during insertion of the cable into a canal or pipe is reduced, so that the cable can be inserted with comparatively lower force into the canal or pipe.

The present invention concerns a cable, especially for installation into a canal or pipe, with a cable core and a cable jacket surrounding the cable core.

For certain applications it is customary, to insert a cable f.e. in the form of an electrical or optical cable into existing or new canal or pipe systems. In case an empty pipe, into which the cable is to be inserted, already exists, the cable has to be subsequently inserted into the respective empty pipe. In this case it is advantageous to blow in, insert or pull a cable of the greatest possible length into pipe systems or empty tubes in order to minimize installation expenses. F.e., for optical transmission networks with optical fiber cables, the distances between the individual repeater stages can be of equal size. This frequently requires the installation of the greatest possible cable lengths into canal or pipe systems.

The insertion of such cables should be done with highest possible speed or high installation output and long cable lengths, respectively. The cable to be inserted must not be subjected to undue stresses. If insertion caterpillars are used to install the cable, they must have sufficiently good gripping capacity or good static friction, respectively, for the cable. Otherwise it is advisable for the friction between the cable and the pipe system to be sufficiently low, in order for the forces necessary to push or pull in the cable to remain relatively low. This is also required, so that sufficiently great cable lengths can be inserted into the pipe system.

To improve the ability to insert or pull in a cable, it is advisable, to equip the pipe system with friction inhibiting inner surfaces. Such inner surfaces could f.e. be made of silicone, Teflon™ or waxes. It is also possible, to alternatively or additionally apply wax to the cable surface. In both cases, additional treatment is necessary for the pipe system and/or the cable.

In EP 0 521 710 A1, an optical fiber arrangement is described, which can be blown into a pipe system for installation. In order to minimize the friction between the arrangement and a pipe, into which the arrangement is to be blown, hollow glass spheres or thin mica plates are arranged on the outer surface of a coating. Such an arrangement generally withstands only comparatively low friction. The distribution of the glass spheres or thin mica plates, respectively, is not homogenous along the longitudinal direction of the cable. The use of insertion rollers can destroy or loosen these spheres on the surface. The arrangement shown is suitable for small elements, where a coating is applied over a few fibers. The arrangement is generally not suitable for outdoor cables.

The objective of the present invention is to make a cable available, which is suitable for installation into a canal or pipe, and which can be inserted into the canal or pipe with comparatively low force.

The objective is achieved with a cable mentioned in the beginning, where the cable jacket has discrete elevations on a base material of the cable jacket, which are formed as continuous longitudinal strips stretching in the longitudinal direction of the cable.

The cable construction according to the invention can be used for different cable types, which are suitable for installation into a canal or pipe. The invention is especially advantageous for optical cables, which are frequently inserted into a canal or pipe with comparatively long cable lengths for bridging large repeater distances.

The cable according to the invention shows longitudinal strips on its surface, which significantly reduce the gliding friction during insertion of the cable into a canal or pipe. The cable jacket shows therefore an outer contour where the contact surface of the cable jacket, coming in contact with the canal or the pipe in the contact area, is smaller than the surface of the cable jacket within this contact area. The discrete elevations on the base material of the cable jacket form an envelope curve having a greater diameter than the envelope curve of the base material of the cable jackets.

When such a cable is inserted, pulled or blown into a pipe, only the elevated longitudinal strips touch the inner wall of the pipe. In case insertion rollers are used, they can still press on the surface areas of the cable jacket base material with comparatively high friction value and therefore obtain a good adhesion. In this way, sufficient traction during the use of insertion rollers is assured, although the cable glides comparatively well inside the pipe. Additionally, empty space between the cable and the pipe wall is created by the discrete elevations, which is filled by surrounding air. This is advantageous for creating air circulation between the cable and the inner wall of the pipe in the contact area of the cable for blowing in the cable.

In an advantageous construction form of the cable according to the invention, the longitudinal strips contain a plastic with embedded silicone. Such a composition shows reduced gliding friction versus the use of pure plastic. It is also wear-resistant and very stable. For the manufacture of the cable, the cable jacket and the longitudinal strips can be co-extruded. The cable according to the invention is especially suited for an outdoor cable.

In another advantageous development of the invention, the cable jacket is formed in several layers, where at least one of the layers is foamed. This achieves a reduction in weight of the cable. In this way, the total cable weight can be reduced up to 15%. It is preferable for the outer layer, where the longitudinal strips are applied, to be solid.

In this case, good traction during use of insertion rollers is assured. In using a cable jacket, where the outer layer is foamed, the traction is significantly improved by using profiled insertion caterpillars or insertion wheels respectively. Foaming facilitates a slight deformation of the cable surface, which leads to a certain form determination with the profiled insertion caterpillars or insertion wheels, respectively. The cable surface is hereby formed as a so-called skin layer, made from a hard material such as HDPE plastic, which has a low fraction value relative to the pipe material and is very wear resistant.

In one construction form of this invention, this skin layer is thinly applied as the outer layer, i.e. it has a thickness of 0.5 to 3 mm. In this way, it can easily be deformed by high surface pressure of the raised areas of the traction bands or traction wheels, respectively, if the material below this skin layer is suitably soft.

The successful softness can be set in large areas preferably by a corresponding foaming of a thermoplastic material. The thermoplastic material softens during heating and can thus be foamed; during cooling it returns to the solid state.

Depending on the cable core construction and requirements of the cable, the inner side of the cable jacket is provided with a further skin layer. In this way, a three-layer cable jacket is the result, where the innermost and outermost layers are each solid. The foaming under the outermost skin layer distributes the high point stresses impacting the cable surface during use of traction bands or traction wheels over a wider surface.

Other advantageous constructions and developments of the invention are characterized in the sub claims.

The invention will be further explained by means of figures shown in the drawings, which depict the construction samples of the invention. Shown are in:

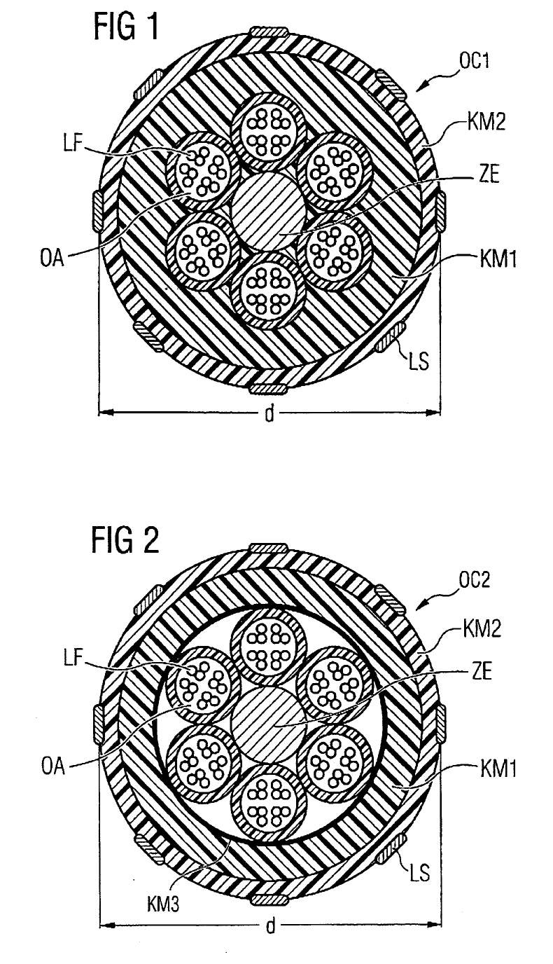

FIG. 1 a construction of a cable according to the invention in the form of an optical cable,

FIG. 2 a further construction of a cable according to the invention, also in the form of an optical cable.

FIG. 1 shows an optical cable OC1, which has a central element ZE made in this sample of GFK material. Optical cores OA in the form of bundles are stranded around this central element ZE. Each of the bundles OA has a multitude of optical fibers LF, which are imbedded in a filling compound. Around this cable core consisting of central element ZE and optical core OA a multi-layer cable jacket is applied, which surrounds the cable core. The cable jacket has a foamed layer KM1 and a skin layer KM2. On the base material of the skin layer KM2 discrete elevations in the form of longitudinal strips LS are applied which are formed a continuous longitudinal strips and stretch along the longitudinal direction either in a straight or helix manner.

The inner layer KM1 is made from approx. 40% foamed MDPE plastic, the outer skin layer KM2 from pure MDPE plastic. The longitudinal strips LS are manufactured from MDPE plastic with embedded silicone. The cable jacket and the longitudinal strips arranged on it can be produced in one work process by co-extrusion or strip extrusion. The embedded silicone in the longitudinal strips significantly reduces the gliding friction of the cable, i.e. the gliding characteristics of the total cable OC1 are significantly improved when pulling it into a canal or pipe.

The cable OC1 in the present construction has a diameter of d=9 mm. For the purpose of weight reduction of the cable, 20-70% hollow space volume is included in the foamed layer KM1. The foaming favors easier deformation of the cable surface and leads therefore to a certain form determination when using profiled insertion caterpillars or insertion wheels for inserting a cable into a pipe system. A sufficiently good gripping capacity or adhesion friction, respectively, to the cable is thus achieved, otherwise the friction between the cable and the pipe is very low due to the longitudinal strips. In this way, the forces needed for insertion are not too great, so that large cable lengths can be inserted into the pipe.

FIG. 2 shows a further construction of a cable according to the invention. The cable OC2 is similar in its essential elements to the cable OC1 shown in FIG. 1; however, the cable jacket in the cable OC2 is formed in three layers. Such a construction can be advantageous for certain cable types and requirements. The cable OC2 has a three-layer jacket in the form of a so-called “skin-foam-skin” jacket. Here the innermost layer KM3 and the outermost layer KM2 are solid and in the form of a skin layer.

1. Cable (OC1), especially for installation into a canal or pipe, with a cable core (ZE, OA) and a cable jacket (KM1, KM2) surrounding the cable core,
characterized by,
the cable jacket (KM2) having discrete elevations on the base material of the cable jacket, which are formed as continuous longitudinal strips stretching in the longitudinal direction of the cable (OC1).

2. Cable according to claim 1,
characterized by,
the longitudinal strips (LS) containing plastic with embedded silicone.

3. Cable according to one of the claims 1 or 2,
characterized by,
the longitudinal strips (LS) being connected or fused in an undetachable manner with the base material of the cable jacket (KM2).

4. Cable according to one of the claims 1 to 3,
characterized by,
the cable jacket (KM1, KM2) being formed in several layers and at least one of the layers (KM 1) being foamed.

5. Cable according to claim 4,
characterized by,
the outermost layer (KM2) being solid.

6. Cable according to claim 4
characterized by,
the cable jacket (KM1, KM2) being formed in at least three layers, where the innermost and outermost layers (KM3, KM2) are each solid.

7. Cable according to one of the claims 5 or 6,
characterized by,
the outermost layer (KM2) showing a thickness of 0.5 to 3 mm.

8. Cable according to one of the claims 4 to 7,
characterized by,
the foamed layer (KM 1) being a thermoplastic material.

9. Cable according to one of the claims 4 to 8,
characterized by,
20 to 70% hollow space volume being included in the foamed layer (KM1).
